(19) United States
(12) Patent Application Publication
(10) Pub. No.: US 2026/0050881 A1
(43) Pub. Date: Feb. 19, 2026

(54) ACCURATE TRANSIT TIME GENERATION WITH LANE-SPECIFIC DATA

(71) Applicant: Walmart Apollo, LLC, Bentonville, AR (US)

(72) Inventors: Ayush Parasbhai Maniar, Ahmedabad (IN); Vamshi Vadla, Bangalore (IN); Sunny Kumar, Muzaffarnagar (IN); Shalini Mandara Ramachandra, Bangalore (IN); Vijay Ramakrishnan, Chennai (IN); Avinash M. Jade, Bangalore (IN); Maheshwar Ramakrishnan, Bangalore (IN); Ankit Tankala, Delhi (IN); Narahari Babu Kannemadugu, Bangalore (IN); Priyansha Agarwal, Shamli (IN); Todd Gene Baumgartner, Bentonville, AR (US)

(21) Appl. No.: 19/289,278

(22) Filed: Aug. 4, 2025

Related U.S. Application Data
(60) Provisional application No. 63/683,880, filed on Aug. 16, 2024.

(51) Int. Cl. G06Q 10/083

(52) U.S. Cl. CPC G06Q 10/0843; G06Q 10/0838

(57) ABSTRACT

Examples provide dynamic delivery promises based on machine learning (ML) predicted transit time to improve promise accuracy and on-time delivery. Actual transit times for previous package deliveries are obtained from historical order data. The actual transit times are weighted based on recency data. A weighted mode is calculated for each shipping lane in a plurality of shipping lanes used to transport packages from a source to a destination location via a carrier method. The mode is calculated based on time period and actual transit times for that time period. Future predicted transit times for each shipping are generated using estimated ship dates and lane-specific modes. The predicted transit times are used to assign a more accurate and reliable delivery promise date to future orders. The promise dates are customized in real-time at a weekday level and a shipping lane level for increased on-time package deliveries.

### BACKGROUND

When a customer places an order online, the customer receives an estimated date at which a package containing one or more of the ordered items is likely to be received by the customer. This expected date of delivery is referred to as a promise date. However, promise dates are generally only reliable during favorable and predictable conditions, which rarely occur. As a result, promise dates are frequently unreliable. This results in unreliable promise dates, packages being delivered too early or too late, unexpected package deliveries, inconvenience for customers, as well as potential customer frustration and dissatisfaction.

### BRIEF DESCRIPTION OF THE DRAWINGS

FIG. 1 is an example block diagram illustrating a system for providing more accurate promise dates using dynamic transit time (TNT) predictions to improve on-time package delivery.

FIG. 2 is an example block diagram illustrating a system for generating more accurate delivery promise dates for packages using dynamically predicted transit times.

FIG. 3 is an example block diagram illustrating a TNT manager for dynamically generating promise dates using more accurate per-lane TNT values.

FIG. 4 is an example block diagram illustrating a TNT manager including a machine learning (ML) model for generating more accurate TNT values used to calculate dynamic promise dates for improved on-time delivery of packages.

FIG. 5 is an example flow chart illustrating operation of the computing device to generate predicted TNT value(s) on a week level and lane level using historical order data.

FIG. 6 is an example flow chart illustrating operation of the computing device to dynamically calculate a more accurate promise date using lane-specific predicted TNT value(s).

FIG. 7 is an example flow chart illustrating operation of the computing device to generate per-lane and per-day of the week TNT predictions using historical TNT data.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

When a customer places an order online, the customer is provided with an estimated date of delivery for the ordered items. This estimated delivery date is referred to as the promise date. Arriving at a highly reliable and accurate promise date is desirable to gain customer trust and to provide a positive shopping experience for customer satisfaction.

The promise dates provided for e-commerce orders depends on the accuracy of the transit time used for order promising. The transit time is the amount of time it takes for a package to arrive at a destination after it leaves the point of origin (source). The transit times for packages are impacted by changing real-world conditions, such as carrier staffing, operational efficiency, weather, road construction, logistics, network congestion, geo-demand, order volume, operational efficiency, etc. There is only limited information about these dynamic future indicators at order time, which makes it impossible for a human to anticipate all the variables impacting delivery time and adequately account for those variables in determining a promise date.

Therefore, transit time predictions provided by carriers are generally only static estimates that hold good only during favorable conditions. These static transit times fail to account for dynamic conditions impacting transit times on a daily basis, which renders many promise dates inaccurate and unreliable. As a result, there are frequent failures to deliver packages containing ordered items by the promise dates for those orders. These inaccurate promise dates result in customer dissatisfaction, unsuccessful delivery attempts, increased delivery attempts, unnecessary communications with customers, potential future loss due to customer dissatisfaction, items returned because of failure to receive the items on-time, customer hesitation to place time-sensitive orders, human resources and computing resources consumed in responding to customer queries regarding orders that failed to arrive on-time, resources expended on items returned due to late delivery, etc.

Aspects of the disclosure solve multiple problems that are necessarily rooted in computer technology, and render use of computing platforms more efficient by providing improved systems and methods for accurate transit time generation with lane-specific data for improved timeliness of item deliveries with reduced system resource usage. In some embodiments, the system reduces the number of inaccurate delivery promise dates which reduces processor usage, network bandwidth usage, and memory usage which would otherwise be consumed in generating inaccurate transit time estimates and erroneous promise dates, thereby reducing system resource usage.

Referring to the figures, examples of the disclosure enable generation of more accurate promise dates using lane-specific and weekday specific predicted transit times. The term weekday, as used herein, refers to the seven days of the week. The term weekday is not limited to Monday through Friday. As used herein, a weekday includes Sunday, Monday, Tuesday, Wednesday, Thursday, Friday, and/or Saturday. In some examples, a transit time (TNT) manager weights historical transit time data for previously delivered packages based on recency data. This enables greater weight to be applied to data for packages delivered most recently, thereby compensating for historical conditions which are no longer relevant to current transit time predictions. This enables improved accuracy of predicted TNT and promise dates for future delivery of packages, thereby reducing late deliveries and improving on-time delivery of packages.

The computing device operates in an unconventional manner by weighting and grouping transit time data for previously delivered packages at a lane level and a weekday (day of the week) level for improved accuracy of future transit times generated using the weighted and grouped historical transit data. In this manner, the computing device is used in an unconventional manner and allows creation of dynamic predicted TNT values which are more dependable and accurate than static TNT values when creating promise dates for future deliveries, thereby improving the reliability of online e-commerce orders created and fulfilled via an online computing system platform.

In other examples, the computing device is used in an unconventional manner where the system generates more accurate predicted transit times at a per-lane level and a weekday level, as well as enabling assignment of reliable promise dates for package delivery with a reduced error rate. In other words, the promise dates more accurately reflect real world transit times for packages via specific shipping lanes reducing errors in transit time predictions which would render the promise dates inaccurate and unreliable. The more accurate predictions and promise dates reduce system resource usage consumed in creating erroneous promise dates, correcting erroneous promise dates, providing customer assistance for item returns due to failure to deliver packages on-time in accordance with promise dates, as well as processor and memory usage consumed in attempting to inaccurately estimate promise dates using unreliable static transit time data, thereby improving functioning of the underlying computing device.

Other embodiments enable presentation of more accurate predicted TNT and promise dates to a user via a user interface device. A user is able to quickly and easily obtain accurate ML generated transit time predictions that reflect current extrinsic conditions influencing transit time via a given shipping lane. The predicted TNT and promise dates are more accurate and dependable, thereby improving user efficiency via UI interaction with improved user efficiency via the UI interaction.

In some embodiments, the simulation based weighted model is characterized by its simplicity and effectiveness, making it suitable for reliable predictions in a variety of situations where historical data for hundreds, thousands or even millions of lanes may be present, as well as working well with smaller datasets, unlike more complex machine learning models that require substantial data. The system improves on-time deliveries while reducing orders to promise (OTP) time. Customers are provided with more accurate promise delivery dates, which reduces both early and late deliveries of packages across multiple shipping lanes.

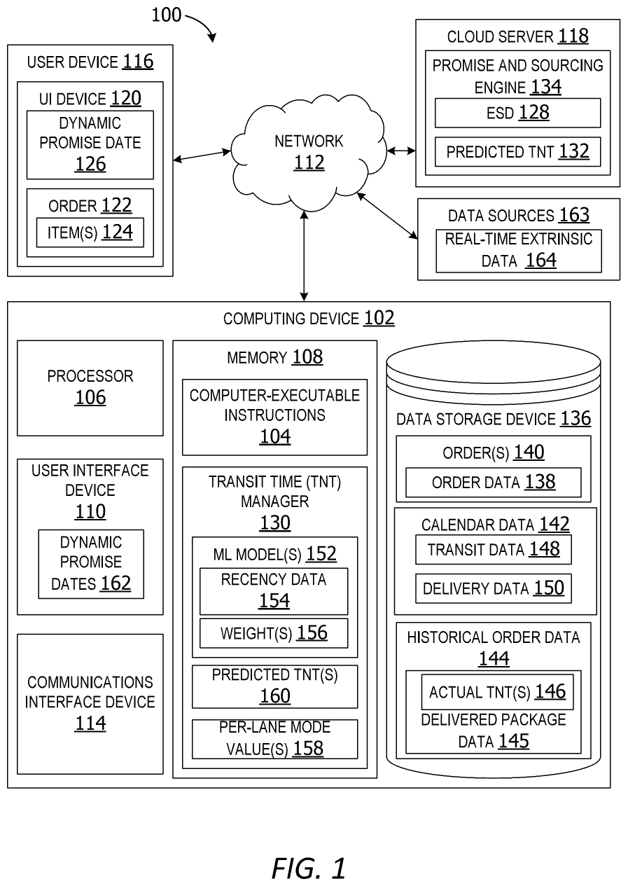

Referring again to FIG. 1, an example block diagram illustrates a system 100 for providing more accurate promise dates using dynamic transit time (TNT) predictions to improve on-time package delivery. A package is any type of item for delivery, including packaged items contained inside a bag, box, or other shipping container. A package also includes an item for delivery that is unpackaged, such as an item that is not bagged, boxed, or otherwise enclosed inside a shipping container.

In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example, but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

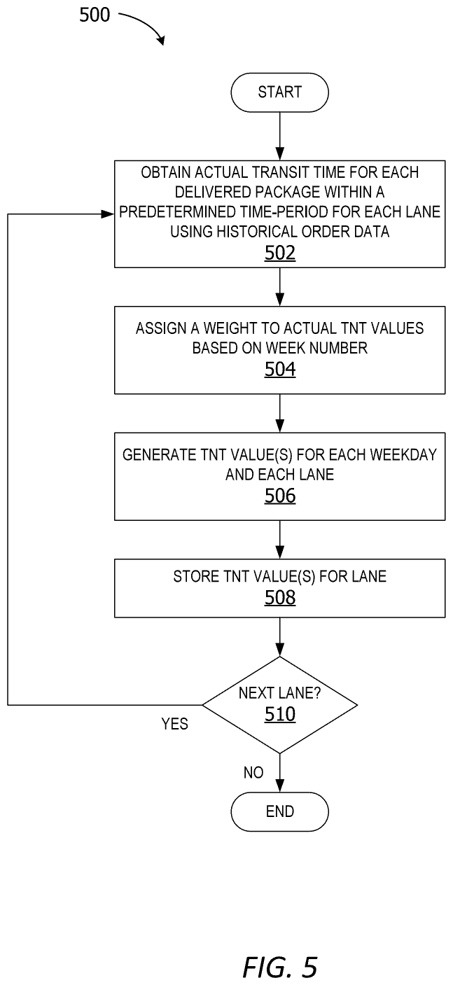

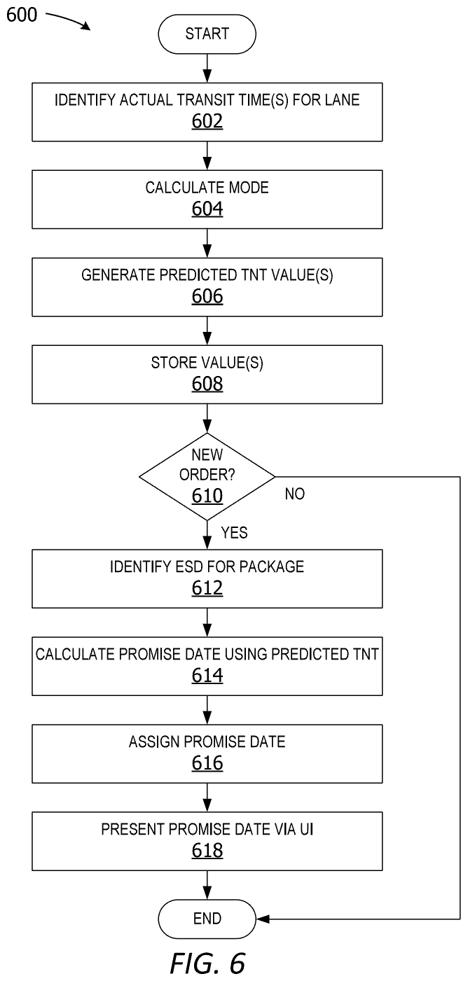

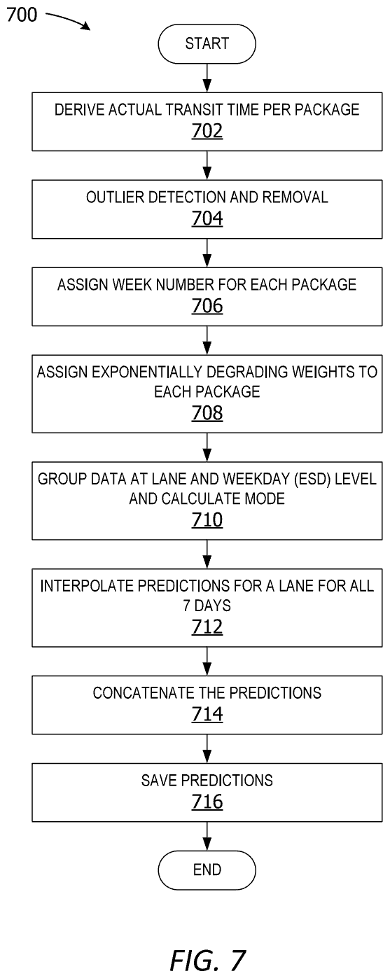

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 5, FIG. 6, and FIG. 7).

The computing device 102 further has one or more computer-readable media such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user, such as one or more dynamic promise dates for one or more customer orders. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120 for receiving data from a user and/or presenting data to a user.

In some examples, the user device 116 is associated with a user creating an online order 122 to purchase one or more item(s) 124 to be delivered in one or more package(s) to a delivery address or other destination. An item is delivered in a package if the item is enclosed in a box or bag and/or the item is unenclosed in a bag or box. The embodiments are not limited to items wrapped in packaging. An item is delivered in one or more package(s) if the item is associated with a shipping label, shipping tag, or other shipping instructions regardless of whether the item is completely enclosed within a package.

In some embodiments, a user is provided with a dynamic promise date 126 indicating an expected date of delivery of the package(s) containing the item(s) 124 in fulfillment of the order 122. The dynamic promise date 126 is a date which is customized based on an estimate ship date (ESD) 128 and a predicted TNT 132 for a specific shipping lane to be used to transport the package(s) to the destination. In this manner, the dynamic promise date 126 provides a more accurate and reliable promise date considering daily and/or weekly changes to actual TNT for packages delivered recently via the same shipping lane.

In some examples, multiple dynamic promise dates 162 are generated for multiple different packages containing items fulfilling one or more customer orders. The multiple dynamic promise dates 162 includes promise dates for the expected arrival of packages, such as the dynamic promise date 126 for the package containing the item(s) 124 for the order 122.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

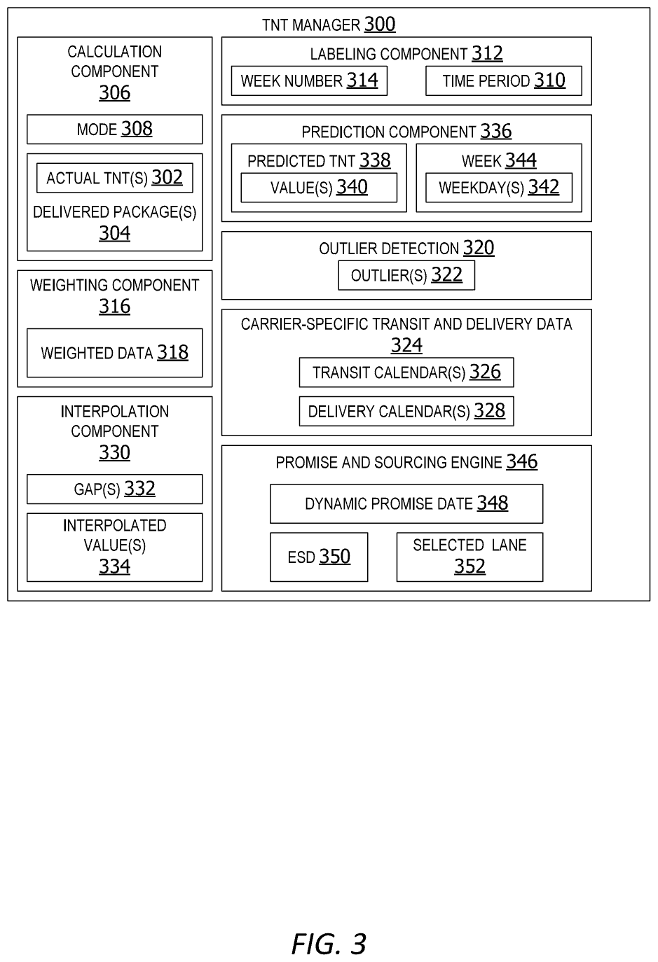

The cloud server 118, in some embodiments, hosts applications or other services, such as, but not limited to, a promise and sourcing engine 134. The promise and sourcing engine is a component implemented in a combination of hardware and software which generates promise dates using predicted TNT data for each shipping lane. In this example, the promise and sourcing engine 134 is included on the cloud server 118. In other embodiments, the promise and sourcing engine 134 is implemented on a computing device, such as, but not limited to, the computing device 102. In some examples, the promise and sourcing engine 134 is incorporated into a transit time (TNT) manager 130, as shown in FIG. 3 below.

In still other embodiments, the promise and sourcing engine 134 is implemented on a same computing device as the TNT manager as a separate component from the TNT manager 130. In these embodiments, the TNT manager and the promise and sourcing engine 134 are communicatively coupled such that the promise and sourcing engine 134 obtains predicted TNT data from the TNT manager, either by requesting the predicted TNT data or by automatically receiving the predicted TNT data from the TNT manager. In still other examples, the promise and sourcing engine 134 obtains the predicted TNT data from a data storage device, such as, but not limited to, the data storage device 136 and/or a cloud storage.

The data storage device 136 is a device for storing data, such as, but not limited to order data 138 associated with one or more unfulfilled order(s) 140, calendar data 142, and/or historical order data 144. The order data 138 includes data associated with unfulfilled orders for one or more items which have not yet been shipped to a recipient or destination address. The order data 138 includes an identification of ordered items, a carrier providing the ordered items, and/or a destination code. A destination code is a code associated with a destination address or other delivery location, such as, but not limited to, a postal zip code. The order data 138 is used to identify a shipping lane to be used to ship items. In some embodiments, the order data 138 includes a user-selected shipping lane.

The calendar data 142 includes carrier-specific transit and delivery data, such as, but not limited to, transit data 148 and/or delivery data 150. Transit data 148 includes transit calendar data identifying which days of the week or month on which a carrier transports packages. For example, if a carrier transports packages on trucks 5 days a week but does not transport packages on the weekends, the transit data 148 includes an indication that transit of packages occurs Monday through Friday, but transit does not occur on Saturday and Sunday. In such cases, any packages that have not reached their intended destination by Friday will remain stationary over the weekend and have to wait until the following Monday before transit of the packages resumes. This impacts transit times for packages being transported by this particular carrier.

The delivery data 150 includes delivery calendar data indicating which days in a week or month the carrier makes deliveries. In one example, the delivery data 150 indicates deliveries occur on all seven days of the week but do not occur on Federal holidays. In such cases, even if a package reaches a transportation hub in the same zip code as its intended destination, the package will not be delivered to the recipient on Thanksgiving or New Year's Day. In another example, the delivery data 150 can indicate the deliveries only occur six days a week but no deliveries are mode on Sunday. In such cases, a package reaching the destination on Saturday night will not be delivered to the address of the recipient during the last leg of package translation until the following Monday.

Historical order data 144 is data associated with fulfilled orders that have already been completed. The historical order data 144 includes delivered package data 145, such as the actual TNT(s) 146 for the already delivered packages. The delivered package data 145 identifies information associated with packages delivered within a predetermined past period of time. In one example, the historical order data 144 includes packages delivered to recipients during the last six weeks. The actual TNT(s) 146 represent the actual transit time taken to deliver each package via each shipping lane during the predetermined time-period. The actual TNT(s) represent actual transit times recorded for each delivered package rather than an estimated or predicted TNT.

In some examples, the TNT manager 130 includes one or more machine learning (ML) model(s) 152. Each ML model in the ML model(s) 152 is a pre-trained ML model for generating predicted TNT values. The ML model(s) 152, in some embodiments, are trained using historical data, such as, but not limited to, the historical order data 144. In this example, one or more ML model(s) 152 generate one or more weight(s) 156 which are applied to the actual TNT(s) 146. The actual TNT(s) 146 are weighted based on recency data 154. In these examples, more recent actual TNTs are weighted more strongly than actual TNTs associated with packages delivered farther in the past. For example, a first actual TNT value for a package delivered within the last week receives a greater weight than a second actual TNT value for a package delivered six weeks ago. This reflects changes in transit conditions, such that the more recent TNT values more accurately reflect current transit times than older TNT values which may not accurately reflect current conditions associated with a given shipping lane.

The data storage device 136 can include one or more different types of data storage devices, such as, for example, one or more rotating disks drives, one or more solid state drives (SSDs), and/or any other type of data storage device. The data storage device 136 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 136 includes a database.

The data storage device 136, in this example, is included within the computing device 102, attached to the computing device, plugged into the computing device, or otherwise associated with the computing device 102. In other examples, the data storage device 136 includes a remote data storage accessed by the computing device via the network 112, such as a remote data storage device, a data storage in a remote data center, or a cloud storage.

The memory 108 in some examples stores one or more computer-executable components, such as, but not limited to, the TNT manager 130. The TNT manager 130 component, when executed by the processor 106 of the computing device 102, obtains actual transit time (TNT) per package for a plurality of delivered packages delivered via a plurality of shipping lanes using historical order data 144. Each lane includes a source (ship node), carrier method (CM), and a destination zip code. The TNT manager 130 calculates one or more per-lane mode(s) 158 for each lane in the plurality of shipping lanes using the actual TNT values for each delivered package in the delivered package data 145. The TNT manager 130 generates lane-specific predicted TNT(s) 160 for each day in a future week using the calculated mode for each lane in the plurality of lanes and the calendar data 142. The predicted TNT(s) 160, in some examples, include seven predicted TNT values for the seven days of a standard week. The TNT manager 130 stores the predicted TNT(s) 160 in the data storage device 136 or any other data storage, such as a database or cloud storage. The stored predicted TNT values for each lane are used to generate dynamic promise dates 126 for the unfulfilled order(s) 140. The dynamic promise dates 126 are output to the user via a UI, such as the UI device 120 on the user device 116 and/or the user interface device 110.

In some examples, the TNT manager 130 identifies an estimated ship date (ESD) 128 for a selected order in the unfulfilled order(s) 140. The TNT manager 130 uses the ESD 128 to determine the weekday on which a package is expected to ship. The weekday, in this example, is a day in a seven day week. The weekdays include Sunday, Monday, Tuesday, Wednesday, Thursday, Friday, and Saturday. In one example, if the ESD 128 indicates the package will ship on October 12, the TNT manager 130 can determine that October 12 falls on a Tuesday. In this example, Tuesday is the weekday on which the package is expected to ship. The promise and sourcing engine 134, in this example, calculates a dynamic promise date for each package using a predicted TNT 132 or the identified weekday of the ESD 128 for each package and the stored lane-specific predicted TNT 132 value for that lane and ESD 128. The calculated dynamic promise date 126 is assigned to the package for the order 122 in this example.

The promise and sourcing engine 134 generates the dynamic promise date 126 and assigns the dynamic promise date to the order 122 in this example.

However, in other embodiments, the TNT manger 130 includes a promise and sourcing engine 134. In such cases, the TNT manager 130 also generates the dynamic promise date 126 or the dynamic promise dates 162 and assigns that dynamic promise date 126 or the dynamic promise dates 162 to each order, thereby improving on-time delivery of packages via the more accurate promise date which reflects real-time changes in shipping lane conditions and dynamic fluctuations in actual transit time for packages delivered via each shipping lane.

In other embodiments, the system 100 includes a plurality of external data sources 163 providing real-time extrinsic data 164. The external data sources 163 include servers and online services providing information regarding weather, construction, traffic, road closures, airport closures, hazardous travel conditions, and other real-time extrinsic information impacting transit times via one or more of the shipping lanes. In these embodiments, the TNT manager 130 obtains the real-time extrinsic data 164 via the network 112. The real-time extrinsic data 164 is used to further modify and/or adjust dynamic TNT predictions generated by the TNT manager 130. In some examples, a ML model 152 analyzes the real-time extrinsic data 164 and utilizes the information to adjust predicted TNT values based on current real-time conditions impacting a selected lane. For example, if a blizzard has closed airports and/or roadways or other travel routes within a shipping lane, the TNT manager 130 adjusts predicted TNT values in real-time, such as by extending the dynamic promise dates 126 or the dynamic promise dates 162 by an amount of time predicted to be sufficient for the airports and/or roadways to reopen after weather conditions have improved.

In some example, the real-time extrinsic data 164 is used as a final optimization step to update predicted TNT values in real-time on a daily basis based on current or unexpected events, such as storms, road closures, or other events likely to negatively impact transit times. In such cases, the predicted TNT values are increased by a predetermined amount to reflect expected delays resulting from the extrinsic circumstances. In one example, if a news or weather data source indicates a hurricane is likely to make landfall in an area that was previously believed to be unimpacted by the hurricane, the system updates predicted TNT values for lanes having travel routes through geographic areas impacted by the hurricane. In this manner, the predicted TNTs 160 are updated in real-time to reflect expected delays due to weather and other current events in that geographic area.

Transit time from one place to another place for the same carrier type generally has less variance due to fixed destination but it can change due to various factors such as traffic, road condition, events etc. The system 100 focuses on increasing the accuracy of predicting the transit time by considering the mode of all historical values in the level. While some factors exhibit a seasonal nature, others follow a trend. For instance, weekday mornings may experience increased traffic, representing a seasonal factor. Simultaneously, trend factors, such as heightened carrier load this year, impacting transit time due to slow vehicle speed and increased on-boarding time, can be accommodated by implementing an exponential moving average as a weighted mechanism in the mode.

In some examples, the TNT manager 130 employs exponential degrading weights, which provide greater weight to more recent historical data over historical data from orders from farther in the past going backwards in time. This provides more weightage to recent observations which allows the model to be sensitive to recent external changes while minimizes fluctuations due to temporary changes occurring in the past which may no longer be relevant to the TNT determination. The use of recency data to weight data in mode-based models improves the accuracy and reliability of the predicted TNT 132 for each order and each delivery lane. This methodology has broader applicability beyond transit time estimation, particularly in scenarios with open-ended classes and a focus on maximum likelihood.

Recency effect aims at providing more weightage to recent orders. If no recency effect is used (all orders treated equally), the predictions generated can be unreliable due to recent change in transit attributes. In such cases, the predictions may yield an early delivery or a delivery delay. However, by weighing the data in favor of more recent historical order data, the data for older orders is sufficiently diluted, yielding a more accurate prediction for current orders. The weighting can be used to get better TNT estimation even if less training data is available. It can be applied to other estimation problems as well where the number of classes are open-ended. Moreover, the TNT is easier to calculate and still effective for greater usability and scalability.

In other examples, the simulation based weighted model determines the level at which to make predictions. This level encompasses the most informative column in a data table for the transit data with respect to a target variable. To select the most effective column, the TNT manager evaluates the Gini impurity for each potential column individually. The column with the lowest Gini impurity is then assigned to an empty level, indicating its significance in the context of the target variable. The system keeps adding the columns iteratively into the group based on the criterion of achieving the minimum Gini impurity reduction. The addition of columns proceeds until either the Gini impurity reduction falls below a specified threshold or the number of data points in a new level becomes minimal. In the case of TNT, the levels consist of source, destination, carrier, and day of the week but it can be different with different data or problem. Once the level is determined, the TNT manager 130 calculates the weighted mode for each group. The weights are assigned based on the exponential moving average. If a group has limited information (fewer data points than a specified threshold ‘n’), the weighted mode of the higher-level group is explored. This is achieved by iteratively removing the least important columns, determined by Gini impurity, until the group contains at least ‘n’ data points, or the impurity improvement falls below a specified threshold. The TNT manager 130 sends these TNT predictions for each group as output to the promise and sourcing engine 134 at a predetermined frequency.

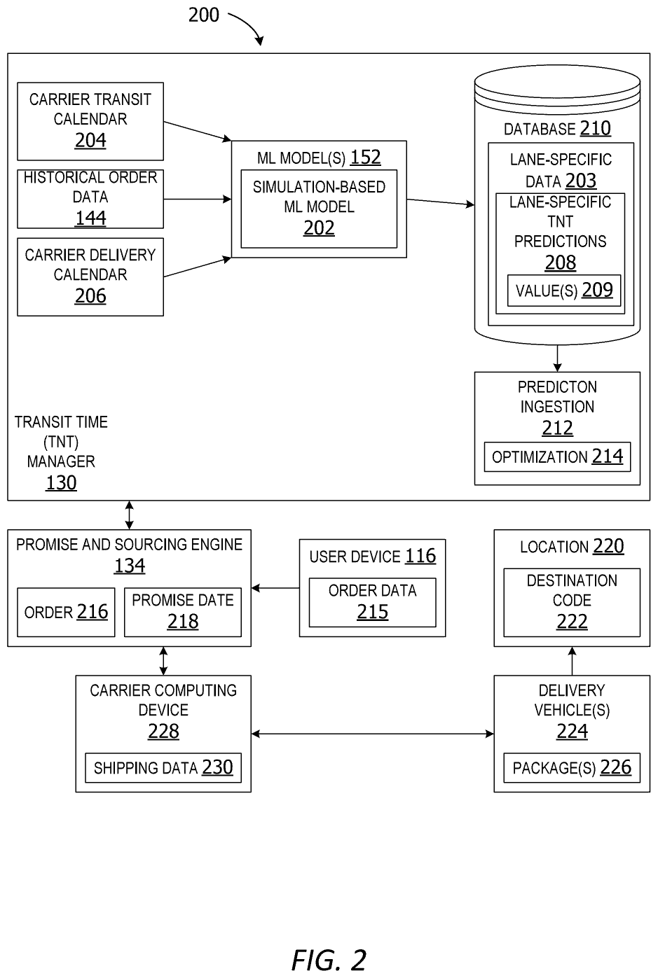

FIG. 2 is an example block diagram illustrating a system 200 for generating more accurate delivery promise dates for packages using dynamically predicted transit times. The TNT manager 130, in this example, includes one or more ML model(s) 152. The one or more ML model(s) 152 includes ML models, such as, but not limited to, a simulation based ML model 202. The simulation based ML model 202 receives inputs, such as, but not limited to, historical order data 144, a carrier transit calendar 204, and/or a carrier delivery calendar 206. The carrier transit calendar 204 is a calendar identifying days a carrier transports packages, such as, but not limited to, the transit data 148 in FIG. 1. The carrier delivery calendar 206 is a calendar identifying days of a week that a specific carrier delivers packages to a destination location, such as, but not limited to, delivery data 150 in FIG. 1.

The ML model(s) 152 derive the actual TNT values for delivered packages and use the actual TNT data to dynamically generate lane-specific data 203, such as, but not limited to, one or more lane-specific TNT predictions 208. The lane-specific TNT predictions 208 include predicted TNT value(s) 209 for each day of at least one future week customized at a day level and a lane level. The lane-specific TNT predictions 208 are stored on a data storage, such as a database 210. A prediction ingestion 212 process optionally performs optimization 214 on the lane-specific TNT predictions 208. In some examples, the optimizations include weighting the predicted TNTs 160 and/or updating the predicted TNTs using real-time data, such as, but not limited to, the real-time extrinsic data 164 in FIG. 1. The optimized predictions are published to the promise and sourcing engine 134.

When order data 215 associated with an order 216 is received from the user device 116, the promise and sourcing engine 134 provides a dynamic promise date 218 generated using the predicted TNT values. The dynamic promise date 218 is an expected date on which one or more package(s) 226 being transported by one or more delivery vehicle(s) 224 of the carrier will be delivered to a location 220 associated with a destination code 222, such as a zip code, provided by the user via the order data 215. Shipping data 230 indicating the actual date of delivery and actual transit times for the package(s) 226 are provided to the TNT manager 130 and/or the promise and sourcing engine 134 via a carrier computing device 228 communicating via a network, such as, but not limited to, the network 112 in FIG. 1. The order data 215 is updated to reflect the actual order date. In some examples, the order data 215 is updated by an order management system or other system for managing order data. The TNT manager 130 utilizes the actual TNT for the package(s) 226 to generate future predicted TNT values for future orders. In other words, shipping data 230 is used to update the historical order data for use in generating future TNT predictions.

Referring now to FIG. 3, an example block diagram illustrating a TNT manager 300 for dynamically generating promise dates using more accurate per-lane TNT values is shown. The TNT manager 300 is a component for generating lane-specific predicted TNT values at a week level and/or generating dynamic promise dates, such as, but not limited to, the TNT manager 130 in FIG. 1 and FIG. 2.

In some examples, a TNT manager 300 obtains actual TNT(s) 302 for one or more previously delivered package(s) 304 from historical data, such as, but not limited to, the historical order data 144 in FIG. 1 and FIG. 2. The calculation component 306 calculates a mode 308 for each shipping lane based on the actual TNT values for packages delivered via each lane within a predetermined time period 310.

In some embodiments, a labeling component 312 labels actual TNT(s) 302 or other transit-related data for delivered package(s) 304 with a week number 314. The week number 314 indicates recency of the actual TNT values. The label can include any type of labeling, such as, but not limited to, alphanumeric labels. In this example, the data is labeled with an integer value indicating recency. For example, if there are sixteen weeks of actual TNT values for packages delivered in the past sixteen weeks, the actual TNT values for packages delivered in the most recent week are labeled as week one and the actual TNT values for packages delivered in the tenth week are labeled as week ten, while packages delivered the farthest in the past at week sixteen are labeled with a week number of sixteen. The time period 310 during which actual TNT values from historical data 144 are utilized is a user configurable time period.

In other embodiments, a weighting component 316 generates weighted data 318. The weighted data 318 includes weighted actual TNT values and/or weighted mode values for each lane. A weighted actual TNT value is an actual TNT value that is weighted based on the recency of the data. In the above example, if actual TNT values for packages delivered in week ten are weighted equally with packages delivered in week one, temporary circumstances existing back during week ten which are no longer true today can result in incorrect TNT predictions for future orders. For example, a thunderstorm in week ten that resulted in a traffic jam may have delayed a number of packages delivered during that week. However, that situation is no longer true in week one and week two. Therefore, week ten is weighted less than week one to reduce the impact of actual transit times that occurred farther in the past. This enables more accurate future predicted TNT(s) 160 as the most recent transit data is given the most weight in calculating future TNTs.

In still other embodiments, an outlier detection 320 detects and removes outlier(s) 322 from the actual TNT(s) 146 data. An outlier is an actual TNT value which deviates significantly from the average range of TNT values for a given lane on a given day or a given week. For example, if three packages are delivered within two days and one package for the same lane is delivered in ten days, the ten day actual TNT is an outlier which likely represents an issue that does not represent the behavior of future TNT, as it might be due to damaged label, a misdirected package, a damaged package, etc.

In another example, if a lane has ten packages going through it and nine of the packages took two to three days for delivery while one package took sixteen days, the sixteen day delivery is an outlier. The outlier skews results if it is allowed to remain in the dataset. Therefore, the system removes these outliers for improved accuracy of the results. Detecting and removing outliers from the actual TNT(s) 146 improves future predicted TNT(s) 160.

In yet other embodiments, the TNT manager 300 includes an interpolation component 330. The interpolation component 330 detects gap(s) 332 in the actual TNT data. A gap refers to a weekday for a given lane for which no historical data is available. In other words, the system does not have access to actual TNT values for a given weekday and lane. In such cases, the interpolation component 330 generates interpolated value(s) 334 to fill in the gap(s) in the data. In some examples, the interpolation component generates interpolation data by taking an average of the actual TNT(s) 146 values for one or more other weekdays for the same week and the same lane. In this manner, predicted TNT 132 values can be generated for every day of the week even in situations in which recent historical order data 144 for that weekday is absent.

The TNT manager 300 in other embodiments utilizes carrier-specific transit and delivery data 324 with the actual TNT values to generate the predicted TNTs. The carrier-specific transit and delivery data 324 include one or more transit calendar(s) 326 and/or one or more delivery calendar(s) 328 for each carrier and each lane. The one or more transit calendar(s) 326 include calendars containing transit data, such as, but not limited to, the transit data 148 in FIG. 1 and/or the carrier transit calendar 204 in FIG. 2. The one or more delivery calendar(s) 328 include carrier-specific delivery data, such as, but not limited to, the delivery data 150 in FIG. 1 and/or the carrier delivery calendar 206 in FIG. 2.

A prediction component 336 utilizes the weighted data 318 to generates one or more predicted TNT 338 value(s) 340 for one or more weekday(s) 342 of a future week 344. The predicted TNT 338 value(s) 340 include one or more lane-specific calculated TNT values for future item deliveries. In this example, the predicted TNT value(s) 340 include a predicted TNT for each of the seven days in the week. The weekday(s) 342 include all days of the week, including Sunday, Monday, Tuesday, Wednesday, Thursday, Friday, and/or Saturday.

In some embodiments, the TNT manager 300 includes a promise and sourcing engine 346. The promise and sourcing engine 346 is a component for generating a dynamic promise date 348, such as, but not limited to, the promise and sourcing engine 134 in FIG. 1 and FIG. 2. The promise and sourcing engine 346 generates the dynamic promise date based on an ESD 350 for an order and a predicted TNT for the selected lane 352 and weekday (day of the week) of the ESD. The weekday level refers to the day of the week level, including all seven days of the week (Sunday through Saturday). The dynamic promise date is output to the user via a UI device, such as, but not limited to, the user interface device 110 and/or the UI device 120 in FIG. 1. The weekday of the ESD can include Sunday, Monday, Tuesday, Wednesday, Thursday, Friday, and/or Saturday.

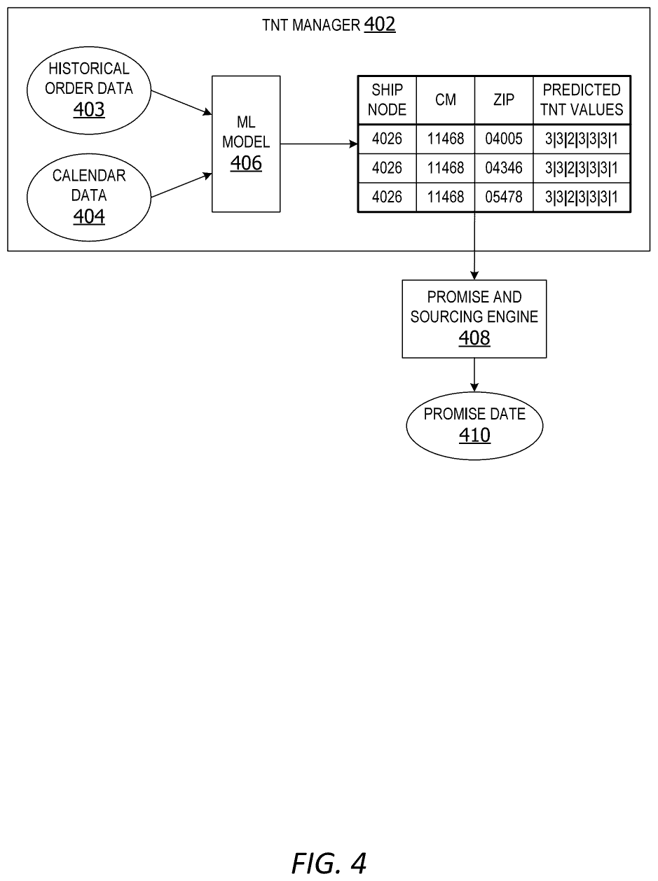

FIG. 4 is an example block diagram illustrating a TNT manager 402 including a machine learning (ML) model 406 for generating more accurate TNT values used to calculate dynamic promise dates 126 or dynamic promise dates 162 for improved on-time delivery of packages. The TNT manager 402 is a component for generating predicted TNT values using actual TNT values from historical package deliveries, such as, but not limited to, the TNT manager 130 in FIG. 1, the TNT manager 130 in FIG. 2, and/or the TNT manager 300 in FIG. 3.

The TNT manager 402 receives inputs, such as, but not limited to, historical order data 403 and calendar data 404. The historical order data 403 is data associated with fulfilled orders, such as, but not limited to, the historical order data 144 in FIG. 1. The calendar data 404 includes carrier-specific transit and delivery data, such as, but not limited to, the calendar data 142 in FIG. 1, the carrier transit calendar 204 and the carrier delivery calendar 206 in FIG. 2, and/or the carrier-specific transit and delivery data 324 in FIG. 3.

In this example, a ML model 406 analyzes actual TNT data obtained from the historical order data 403 with the calendar data 404 for each lane to generate predicted TNT values. The ML model 406 is a model, such as, but not limited to, the one or more ML model(s) 152 in FIG. 1, the one or more ML models 152 in FIG. 2, and/or the simulation based ML model 202 in FIG. 2. The lane-level data includes the source (ship node), carrier method (CM), and destination code (zip). A promise and sourcing engine 408 pulls the predicted TNT 132 values for each lane and generates a lane-specific promise date 410 for each order at a weekday (day of the week) level.

The Predicted TNT 132 data gets refreshed every day, as shown in FIG. 4. This allows different models to be rigorously tested and seamlessly consumed by the promise and sourcing engine. The estimation of transit time at a weekday of estimated shipping date (ESD) level is used for segregation of lane level data based on Gini impurity/diversity index (a common heuristic used for identification of features for best split in decision tree models). The exponential degrading weights historical data going backwards farther into the past to provide greater importance to recent observations. This allows the model to be sensitive to recent external changes. This methodology has broader applicability beyond transit time estimation, particularly in scenarios with open-ended classes and a focus on maximum likelihood.

FIG. 5 is an example flow chart illustrating operation of the computing device to generate predicted TNT value(s) on a week level and lane level using historical order data. The process 500 shown in FIG. 5 is performed by a customized TNT manager 130 component, executing on a computing device, such as the computing device 102 or the user device 116 in FIG. 1.

The process begins by obtaining actual transit time for each delivered package using historical order data at 502. Actual transit time is the time it actually took to deliver a package in the past, such as, but not limited to, the actual TNT(s) 146 in FIG. 1. The TNT manager assigns a weight to the actual TNT values based on week number at 504. The week number is a number indicating recency of the actual TNT values, such as the week number 314 in FIG. 3. The TNT manager is a component for predicting more accurate transit times using estimated ship dates and lane-specific, actual TNT values for previously delivered packages, such as, but not limited to, the TNT manager 130 in FIG. 1. The TNT manager generates one or more TNT value(s) for each weekday and each lane at 506. The TNT manager stores the generated TNT values for each lane at 508. The predicted TNT values are stored in a device, such as, but not limited to, the data storage device 136 in FIG. 1. The TNT manager determines if there is a next lane for which predicted TNT values are needed at 510. If yes, the system iteratively executes operations 502 through 510 until predicted TNT values are generated for each day of a future week and each shipping lane. If predicted TNT values have been generated and stored for every lane at 510, the process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an example flow chart illustrating operation of the computing device to dynamically calculate a more accurate promise date using lane-specific predicted TNT value(s). The process 600 shown in FIG. 6 is performed by a customized TNT manager component, executing on a computing device, such as the computing device 102 or the user device 116 in FIG. 1.

The process begins by identifying actual transit time(s) for a lane at 602. The TNT manager calculates a mode at 604. The mode, in some embodiments, is a weighted mode generated using weighted actual TNT data. The TNT manager generates predicted TNT value(s) for the lane at 606. In this example, the TNT value(s) are generated using the calculated mode. The TNT manager stores the predicted TNT value(s) at 608. The predicted TNT values are stored in a data storage, such as the data storage device 136 in FIG. 1. The TNT manager determines if a new order is received at 610. If not, the process terminates thereafter.

If a new order is received at 610, an ESD is identified from the order data for the package at 612. A promise date is calculated using the ESD and predicted TNT values for the lane at 614. The promise date is a dynamic promise date customized at a weekday level and a lane level. The promise date is assigned to the order at 616. The promise date is presented to the user via a UI at 618. The UI is a UI device, such as, but not limited to, the user interface device 110 and/or the UI device 120 in FIG. 1. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an example flow chart illustrating operation of the computing device to generate per-lane and per-weekday TNT predictions using historical TNT data. The process 700 shown in FIG. 7 is performed by a customized TNT manager component, executing on a computing device, such as the computing device 102 or the user device 116 in FIG. 1.

The process begins by deriving actual transit times per package at 702. The actual transit times are derived from historical order data, such as, but not limited to, the historical order data 144 in FIG. 1. Outlier detection and removal is performed at 704. A week number is assigned to each package at 706. The week number indicates recency of the package transit time data. The TNT manager assigns exponentially degrading weights to each package at 708. In some embodiments, the weight are assigned based on the week numbers. The TNT manager groups the weighted data at the lane and weekday (ESD) level and calculates a mode for each lane at 710. The TNT manager interpolates predictions for a lane for all seven days at 712. The interpolations enables the system to generate predictions for lanes on days lacking historical order data for actual transit times for those days and lanes. The TNT manager concatenates the predictions at 714. In these examples, the TNT predictions for all seven days of a week are concatenated together and transmitted together via a single concatenated data string. The predictions are saved at 716. In these examples, the predictions are saved in a data storage device or cloud storage. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

### Additional Examples

The system provides more accurate delivery promises using improved ML predicted transit time for on-time package deliveries. In some embodiments, a TNT manager component utilizes one or more ML models to generate a more accurate and reliable estimation of transit time at a weekday of estimated date level. The weekday ESD enables improved segregation of lane level data based on Gini impurity/diversity index (a common heuristic used for identification of features for best split in decision tree models).

Other examples employ a simulation-based weighted model which is characterized by its simplicity of use and effectiveness, making it suitable for reliable predictions even with smaller datasets, unlike more complex machine learning models that require substantial data. Ensemble modeling allows onboarding of different models seamlessly and publishes data to the promise and sourcing engine without changes to the engine. This results in an increase in on-time delivery/accurate promise date with ML predicted TNT. It also results in fewer missed order promises. The increased conversion rate, due to quicker and lesser promised times, is expected to increase revenue while decreasing costs.

In still other embodiments, the TNT manager sends the predicted TNT predicted by system only to the promise and sourcing engine which uses it to generate the promise date for each order. This is seamless to the customer during the order placing process for improved user interaction via the user interface while also reducing user time consumed while placing an order. Moreover, dynamic lane level data is further utilized with weekday of ESD as a feature where packages are weighted by recency. This enables the TNT manager to generate the best (most accurate) TNT for each order customized based on lane-specific data, which further reflects the variance in transit times due to lane-specific differences.

In other embodiments, to have better transit time estimation, the system employs an end-to-end ML pipeline which predicts the transit time with greater accuracy. In this example, the TNT manager uses a simulation based weighted model. However, other models can also be used depending on the requirements.

In other examples, the TNT manager, using a ML Transit Time (TNT) model, takes Historical shipments, Carrier Transit and Delivery calendars as input. Different carrier methods have different transit and delivery calendars. Transit and delivery calendars are a binary integer list of 7 days. That signifies on which particular weekday that carrier method works. There is a transit calendar that signifies when packages are in transit.

In other embodiments, the TNT manager generates a predicted TNT for each Lane. The lane includes three components, the source (fulfillment center), the carrier method (CM), and the destination zip code where the package is being sent for delivery. The ESD and day for shipping the package from the source is obtained. The system determines the ESD for a shipment from the order data. The ESD and predicted TNT for the lane are used to generate the promise date. The predicted TNT obtained from the stored lane-specific predicted TNT values in the data storage device.

In some embodiments, once the TNT manager generates the TNT predictions, the predicted TNTs are concatenated across the week for that lane for transmission to the promise and sourcing engine. The concatenated TNT predictions are sent to the promising and sourcing engine via a supply chain data/entity management system. When a customer places an order, the promise and sourcing engine is called. The promise and sourcing engine uses the predicted TNT to assign a promise date to the customer/estimated delivery date when package will arrive.

In other embodiments, the system utilizes a trained ML TNT prediction model for estimating delivery time/transit time of a package. The trained ML model takes historical order history data, carrier transit calendars, and carrier delivery calendars to derive an actual transit time per package in past orders. The ML model detects and removes outliers from the actual transit time per package data. The ML model labels each package with a week number associated with package delivery in the historical data. The ML model applies a weighting to the labeled data by exponentially degrading weights based on time for each package. The ML model groups the weighted data by lane at a weekday level associated with an estimated ship date to calculate a mode for each lane. Each lane is a unique combination of ship node, carrier method, and destination zip code. The mode is calculated based on time period and transit time for the time period. The ML model interpolates predictions for an individual lane across all days of a week based on the calculated mode for the individual lane. The ML model concatenates the predictions to output to a predicted ingestion process (which optimizes the prediction for ingestion by a promise and sourcing engine configured to estimate promised delivery dates for a future shipment). The method buffers the trained ML prediction model with recency data (geographic data, change data associated with a geographic region, weather data, holiday, or seasonal data, etc.) at runtime. The recency data includes local and global events that is autonomously obtained from external data sources and is fetched weekly or at short intervals of time. The buffer is time-limited based on the nature of the recency data. The method uses the trained model for prediction of lead time (from time order is placed to shipment date) at runtime. This enables provision of improved delivery promise estimation and more on-time deliveries of packages.

Alternatively, or in addition to the other examples described herein, examples include any combination of the following:
detect an outlier actual TNT associated with a previously delivered package described in the historical order data;
remove the outlier actual TNT from a plurality of actual TNT values derived from the historical order data, the plurality of actual TNT values grouped at a weekday level;
label each actual TNT value for each package with a week number associated with a week in which package delivery occurred relative a predetermined time-period corresponding to the historical order data;
weight a first set of actual TNT values labeled with a first week number indicating recent package delivery with greater weight than a second set of actual TNT values labeled with a second week number, wherein the first set of actual TNT values correspond to a first set of packages delivered more recently than a second set of packages associated with the second set of TNT values;
identify a weekday in a seven-day week for which actual TNT values for a selected lane in the plurality of lanes are unavailable in the historical order data;
interpolate a predicted TNT for the identified weekday using the mode for the selected lane and transit calendar data for the selected lane;
concatenate a set of seven predicted TNT values for a selected future week associated with a selected lane into a concatenated data string;
transmit the concatenated data string to a promise and sourcing engine for use in generating the dynamic promise date for each unfilled order;
group actual TNT values by lane at a weekday level associated with an estimated ship date in the data storage device, wherein a weighting of the actual TNT values are updated on a weekly basis to reflect changes more accurately in TNT across the plurality of lanes in response to dynamically changing local and global events impacting actual TNT values each week;
train a machine learning (ML) model using the historical order data and recency data, wherein the recency data comprises local and global event data impacting TNT retrieved on a weekly basis;
generate the predicted TNT values by the trained ML model using the mode, carrier transit calendar data, and carrier delivery calendar data;
obtaining actual transit time (TNT) per package for a plurality of packages delivered via a plurality of lanes using historical order data, wherein a lane comprises a source, carrier method (CM), and a destination code;
calculating a mode for each lane in the plurality of lanes using the actual TNT per package for the plurality of packages delivered via the plurality of lanes;
generating lane-specific predicted TNT values for each weekday in a future week using the calculated mode for each lane in the plurality of lanes and carrier-specific transit and delivery calendar data for each lane;
storing the lane-specific predicted TNT values in a data storage device for use in generating more accurate promise dates for future package deliveries, wherein a dynamic promise date is calculated for each unfilled order using an ESD and a predicted TNT value corresponding to a weekday of the ESD increasing on-time delivery of packages;
labeling package data for each package identified in the historical order data with a week number;
weighting the labeled package data by exponentially degrading weights based on the week number assigned to each package, wherein a greater weight is assigned to labeled package data having an earlier week number indicating a more recently delivered package;
identifying an estimated ship date (ESD) for each package expected to be shipped via each lane within a selected week in accordance with unfulfilled orders, wherein the ESD comprises an identification of a selected weekday for package shipment;
calculating a dynamic promise date for each package using a predicted TNT for an identified weekday of the ESD for each package obtained from the stored lane-specific predicted TNT values;
assigning the calculated dynamic promise date to each package for timely fulfillment of the unfulfilled orders via the plurality of lanes;
identifying a weekday in a seven-day week for which actual TNT values for a selected lane in the plurality of lanes are unavailable in the historical order data;
interpolating a predicted TNT for the identified weekday using the mode for the selected lane and transit calendar data for the selected lane;
concatenating a set of seven predicted TNT values for a selected future week associated with a selected lane into a concatenated data string;
transmitting the concatenated data string to a promise and sourcing engine for use in generating the dynamic promise date for each unfilled order;
calculating a unique predicted TNT value for each day in a seven-day week, wherein a new set of predicted TNT values comprising seven unique predicted TNT values for each day in the seven-day week are generated for each week of a year based on a new calculated mode and carrier-specific transit and delivery calendar data;
training a machine learning (ML) model using the historical order data and recency data, wherein the recency data comprises geographic data, change data associated with a geographic region, weather data, holidays, and seasonal data obtained on a daily basis;
generating a plurality of predicted TNT values by the trained ML model using the mode, carrier transit calendar data, and carrier delivery calendar data;
weighting package delivery data associated with a plurality of delivered packages based on recency data associated with an actual date of delivery for each package to form weighted package data for the plurality of delivered packages;
grouping the weighted package delivery data by lane at a weekday level;
identifying a gap in actual TNT values for a selected lane in the plurality of lanes, wherein the gap represents a weekday for which actual TNT values for the selected lane are unavailable in the historical order data;
interpolating a predicted TNT for the identified weekday using the mode for the selected lane and transit calendar data for the selected lane;
concatenate a set of seven predicted TNT values for a selected future week associated with a selected lane into a concatenated string of integers;
transmit the concatenated string of integers to a cloud server for use in generating the dynamic promise date for each unfilled order;
weighting actual TNT values based on recency of order delivery;
grouping the weighted TNT values by lane at a weekday level associated with an estimated ship date to calculate a weighted for each lane, wherein a weighted mode reflects changes in average delivery time for each lane due to dynamically changing events; and
generating predicted TNT values using lane-specific weighted historical data, including the weighted TNT values grouped by lane, wherein the predicted TNT values reflect real-time changes impacting TNT values for each lane on a daily basis for more accurate TNT predictions.

At least a portion of the functionality of the various elements in FIG. 1, FIG. 2, FIG. 3, and FIG. 4 can be performed by other elements in FIG. 1, FIG. 2, FIG. 3, and FIG. 4, or an entity (e.g., processor 106, web service, server, application program, computing device, etc.) not shown in FIG. 1, FIG. 2, FIG. 3, and FIG. 4.

In some embodiments, the operations illustrated in FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of accurate transit time (TNT) prediction improving on-time delivery of packages, the method comprising obtaining actual transit time (TNT) per package for a plurality of packages delivered via a plurality of lanes using historical order data, wherein a lane comprises a source, carrier method (CM), and a destination code; calculating a mode for each lane in the plurality of lanes using the actual TNT per package for the plurality of packages delivered via the plurality of lanes; generating lane-specific predicted TNT values for each weekday in a future week using the calculated mode for each lane in the plurality of lanes and carrier-specific transit and delivery calendar data for each lane; and storing the lane-specific predicted TNT values in a data storage device for use in generating more accurate promise dates for future package deliveries, wherein a dynamic promise date is calculated for each unfilled order using an ESD and a predicted TNT value corresponding to a weekday of the ESD increasing on-time delivery of packages.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Example Operating Environment

Example computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an example computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute example means for accurate transit time (TNT) prediction improving on-time delivery of packages. For example, the elements illustrated in FIG. 1, FIG. 2, FIG. 3, and FIG. 4, such as when encoded to perform the operations illustrated in FIG. 5, FIG. 6, and FIG. 7, constitute example means for identifying actual transit time (TNT) per package for a plurality of delivered packages delivered via a plurality of lanes using historical order data, wherein a lane comprises a source, carrier method (CM), and a destination code; example means for calculating a mode for each lane in the plurality of lanes using the actual TNT per package for the plurality of delivered packages; example means for generating lane-specific predicted TNT values for each weekday in a future week using the calculated mode for each lane in the plurality of lanes and carrier-specific transit and delivery calendar data for each lane; example means for storing the lane-specific predicted TNT values in a data storage device for use in generating more accurate promise dates for future package deliveries; example means for calculating a dynamic promise date for each package using a predicted TNT for an identified weekday of an estimated ship date (ESD) for each package expected to be shipped via each lane, the predicted TNT obtained from the stored lane-specific predicted TNT values; and example means for assigning the calculated dynamic promise date to each package, wherein dynamic promise dates improve on-time delivery of packages.

Other non-limiting examples provide one or more computer storage devices having a first computer-executable instructions stored thereon for providing dynamic promise dates for improving on-time delivery of packages. When executed by a computer, the computer performs operations including identify actual transit time (TNT) per package for a plurality of delivered packages delivered via a plurality of lanes using historical order data, wherein a lane comprises a source, carrier method (CM), and a destination code; calculate a mode for each lane in the plurality of lanes using the actual TNT per package for the plurality of delivered packages; generate lane-specific predicted TNT values for each weekday in a future week using the calculated mode for each lane in the plurality of lanes and carrier-specific transit and delivery calendar data for each lane; store the lane-specific predicted TNT values in a data storage device for use in generating more accurate promise dates for future package deliveries; calculate a dynamic promise date for each package using a predicted TNT for an identified weekday of an estimated ship date (ESD) for each package expected to be shipped via each lane, the predicted TNT obtained from the stored lane-specific predicted TNT values; and assign the calculated dynamic promise date to each package, wherein dynamic promise dates improve on-time delivery of packages.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A”and “B”(optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for accurate transit time (TNT) generation using lane-specific data, the system comprising:
a processor; and
a computer-readable medium storing instructions that are operative upon execution by the processor to:
identify actual transit time (TNT) per item for a plurality of items delivered via a plurality of lanes using historical data, wherein a lane comprises a source, carrier method (CM), and a destination code;
calculate a mode for each lane in the plurality of lanes using the actual TNT per item for the plurality of delivered items;
generate lane-specific TNT values for each day of a future week using the calculated mode for each lane in the plurality of lanes and carrier-specific transit and delivery calendar data for each lane;
calculate a dynamic promise date for each item using a calculated TNT for an identified day of an estimated ship date (ESD) for each item expected to be shipped via each lane using the lane-specific TNT values; and
assign the dynamic promise date to each item for improved on-time delivery.

2. The system of claim 1, wherein the instructions are further operative to:
detect an outlier actual TNT associated with a previously delivered package described in the historical data; and
remove the outlier actual TNT from a plurality of actual TNT values derived from the historical data, the plurality of actual TNT values grouped at a weekday level.

3. The system of claim 1, wherein the instructions are further operative to:
label each actual TNT value for each package with a week number associated with a week in which package delivery occurred relative to a predetermined time-period corresponding to the historical data; and
weight a first set of actual TNT values labeled with a first week number indicating recent package delivery with greater weight than a second set of actual TNT values labeled with a second week number, wherein the first set of actual TNT values correspond to a first set of packages delivered more recently than a second set of packages associated with the second set of TNT values.

4. The system of claim 1, wherein the instructions are further operative to:
identify a weekday in a seven-day week for which actual TNT values for a selected lane in the plurality of lanes are unavailable in the historical data; and
interpolate a predicted TNT for the identified weekday using the mode for the selected lane and transit calendar data for the selected lane.

5. The system of claim 1, wherein the instructions are further operative to:
concatenate a set of seven predicted TNT values for a selected future week associated with a selected lane into a concatenated data string; and
transmit the concatenated data string to a promise and sourcing engine for use in generating the dynamic promise date for each unfilled order.

6. The system of claim 1, wherein the instructions are further operative to:
group actual TNT values by lane at a weekday level associated with an estimated ship date in a data storage device, wherein a weighting of the actual TNT values are updated on a weekly basis to reflect changes more accurately in TNT across the plurality of lanes in response to dynamically changing local and global events impacting actual TNT values each week.

7. The system of claim 1, wherein the instructions are further operative to:
train a machine learning (ML) model using the historical data and recency data, wherein the recency data comprises local and global event data impacting TNT retrieved on a weekly basis; and
generate the lane-specific TNT values by the trained ML model using the mode, carrier transit calendar data, and carrier delivery calendar data.

8. A method for accurate transit time (TNT) generation using lane-specific data, the method comprising:
obtaining actual transit time (TNT) per item for a plurality of items delivered via a plurality of lanes using historical order data, wherein a lane comprises a source, carrier method (CM), and a destination code;
calculating a mode for each lane in the plurality of lanes using the actual TNT per item for the plurality of items delivered via the plurality of lanes;
generating lane-specific TNT values for each weekday in a future week using the calculated mode for each lane in the plurality of lanes and carrier-specific transit and delivery calendar data for each lane; and
storing the lane-specific TNT values in a data storage device for use in generating more accurate promise dates for future item deliveries, wherein a dynamic promise date is calculated for each unfilled order using an ESD and a lane-specific TNT value corresponding to a weekday of the ESD increasing on-time delivery of packages.

9. The method of claim 8, further comprising:
labeling package data for each package identified in the historical order data with a week number; and
weighting the labeled package data by exponentially degrading weights based on the week number assigned to each package, wherein a greater weight is assigned to labeled package data having an earlier week number indicating a more recently delivered package.

10. The method of claim 8, further comprising:
identifying an estimated ship date (ESD) for each package expected to be shipped via each lane within a selected week in accordance with unfulfilled orders, wherein the ESD comprises an identification of a selected weekday for package shipment;
calculating a dynamic promise date for each package using a predicted TNT for an identified weekday of the ESD for each package obtained from the stored lane-specific TNT values; and
assigning the calculated dynamic promise date to each package for timely fulfillment of the unfulfilled orders via the plurality of lanes.

11. The method of claim 8, further comprising:
identifying a weekday in a seven-day week for which actual TNT values for a selected lane in the plurality of lanes are unavailable in the historical order data; and
interpolating a predicted TNT for the identified weekday using the mode for the selected lane and transit calendar data for the selected lane.

12. The method of claim 8, further comprising:
concatenating a set of seven predicted TNT values for a selected future week associated with a selected lane into a concatenated data string; and
transmitting the concatenated data string to a promise and sourcing engine for use in generating the dynamic promise date for each unfilled order.

13. The method of claim 8, further comprising:
calculating a unique predicted TNT value for each day in a seven-day week, wherein a new set of predicted TNT values comprising seven unique predicted TNT values for each day in the seven-day week are generated for each week of a year based on a new calculated mode and carrier-specific transit and delivery calendar data.

14. The method of claim 8, further comprising:
training a machine learning (ML) model using the historical order data and recency data, wherein the recency data comprises geographic data, change data associated with a geographic region, weather data, holidays, and seasonal data obtained on a daily basis; and
generating a plurality of predicted TNT values by the trained ML model using the mode, carrier transit calendar data, and carrier delivery calendar data.

15. One or more computer storage devices having computer-executable instructions stored thereon, which, upon execution by a computer, cause the computer to perform operations comprising:
deriving actual transit time (TNT) per package for a plurality of delivered packages using historical order data for a plurality of packages delivered via a plurality of lanes, wherein a lane comprises a source, carrier method (CM), and a destination code;
calculating a mode for a selected lane in the plurality of lanes using the derived actual TNT per package for packages delivered using the selected lane;
generating lane-specific TNT values for each weekday in a future week using the calculated mode for the selected lane in the plurality of lanes and carrier-specific transit and delivery calendar data for the selected lane;
storing the lane-specific TNT values in a data storage device for use in generating more accurate promise dates for future package deliveries via the selected lane;
identifying an estimated ship date (ESD) for each package expected to be shipped via the selected lane within a selected week in accordance with unfulfilled orders, wherein the ESD comprises an identification of a selected weekday for package shipment;
calculating a dynamic promise date for each package using a predicted TNT for an identified weekday of the ESD for each package obtained from the stored lane-specific TNT values; and
assigning the calculated dynamic promise date to each package, wherein dynamic promise dates improve on-time delivery of packages enabling more accurate fulfillment of the unfulfilled orders.

16. The one or more computer storage devices of claim 15, wherein the operations further comprise:
labeling each package in a plurality of packages with a week number associated with an actual package delivery in the historical order data.

17. The one or more computer storage devices of claim 15, wherein the operations further comprise:
weighting package delivery data associated with a plurality of delivered packages based on recency data associated with an actual date of delivery for each package to form weighted package data for the plurality of delivered packages; and
grouping the weighted package delivery data by lane at a weekday level.

18. The one or more computer storage devices of claim 15, wherein the operations further comprise:
identifying a gap in actual TNT values for a selected lane in the plurality of lanes, wherein the gap represents a weekday for which actual TNT values for the selected lane are unavailable in the historical order data; and
interpolating a predicted TNT for the identified weekday using the mode for the selected lane and transit calendar data for the selected lane.

19. The one or more computer storage devices of claim 15, wherein the operations further comprise:
concatenate a set of seven predicted TNT values for a selected future week associated with a selected lane into a concatenated string of integers; and
transmit the concatenated string of integers to a cloud server for use in generating the dynamic promise date for each unfilled order.

20. The one or more computer storage devices of claim 15, wherein the operations further comprise:
weighting actual TNT values based on recency of order delivery;
grouping the weighted TNT values by lane at a weekday level associated with an estimated ship date to calculate a weighted for each lane, wherein a weighted mode reflects changes in average delivery time for each lane due to dynamically changing events; and
generating predicted TNT values using lane-specific weighted historical data, including the weighted TNT values grouped by lane, wherein the predicted TNT values reflect real-time changes impacting TNT values for each lane on a daily basis for more accurate TNT predictions.
